(19) United States
(12) Patent Application Publication
(10) Pub. No.: US 2025/0253909 A1
(43) Pub. Date: Aug. 7, 2025

(54) METHOD AND APPARATUS FOR TRANSMISSION AND RECEPTION OF CHANNEL STATE INFORMATION IN COMMUNICATION SYSTEM

(71) Applicant: Samsung Electronics Co., Ltd., Suwon-si (KR)

(72) Inventors: Di SU, Beijing (CN); Zhe CHEN, Beijing (CN); Peng LIN, Beijing (CN); Chen QIAN, Beijing (CN)

(21) Appl. No.: 19/037,953

(22) Filed: Jan. 27, 2025

(30) Foreign Application Priority Data
Feb. 2, 2024 (CN) 202410155904.5
Aug. 26, 2024 (CN) 202411179776.4

(51) Int. Cl. H04B 7/06; H04L 5/00; H04W 24/10

(52) U.S. Cl. CPC H04B 7/0626; H04L 5/0005; H04W 24/10

(57) ABSTRACT

The disclosure relates to a fifth generation (5G) or sixth generation (6G) communication system for supporting a higher data transmission rate. A method performed by a user equipment (UE) in a wireless communication system is provided. The method comprises receiving, from a base station, configuration information including information on a plurality of frequency units of a channel state information (CSI) reference signal (RS), performing a channel measurement based on the plurality of frequency units of the CSI RS and transmitting, to the base station, a CSI report including a channel measurement result of the channel measurement, wherein the channel measurement result is associated with at least one frequency unit among the plurality of frequency units.

### CROSS-REFERENCE TO RELATED APPLICATION(S)

This application is based on and claims priority under 35 U.S.C. § 119 (a) of a Chinese patent application number 202410155904.5, filed on Feb. 2, 2024, in the Chinese Intellectual Property Office, and of a Chinese patent application number 202411179776.4, filed on Aug. 26, 2024, in the Chinese Intellectual Property Office, the disclosure of each of which is incorporated by reference herein in its entirety.

### BACKGROUND

### 1. Field

The disclosure relates to communication technologies. More particularly, the disclosure relates to a method and an apparatus for transmission and reception of channel state information (CSI) in a communication system.

### 2. Description of Related Art

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mm Wave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for transmission and reception of channel state information (CSI) in a communication system.

Additional aspects will be set forth in part in the description which follows and, in part, will be apparent from the description, or may be learned by practice of the presented embodiments.

A method performed by a user equipment (UE) in a wireless communication system is provided. The method comprises receiving, from a base station, configuration information including information on a plurality of frequency units of a channel state information (CSI) reference signal (RS), performing a channel measurement based on the plurality of frequency units of the CSI RS and transmitting, to the base station, a CSI report including a channel measurement result of the channel measurement, wherein the channel measurement result is associated with at least one frequency unit among the plurality of frequency units.

A method performed by a base station in a wireless communication system is provided. The method comprises transmitting, to a user equipment (UE), configuration information including information on a plurality of frequency units of a channel state information (CSI) reference signal (RS), transmitting, to the UE, the CSI RS for a channel measurement associated with the plurality of frequency units of the CSI RS and receiving, from the UE, a CSI report including a channel measurement result of the channel measurement, wherein the channel measurement result is associated with at least one frequency unit among the plurality of frequency units.

A user equipment (UE) in a wireless communication system is provided. The UE comprises a transceiver and a controller coupled with the transceiver and configured to receive, from a base station, configuration information including information on a plurality of frequency units of a channel state information (CSI) reference signal (RS), perform a channel measurement based on the plurality of frequency units of the CSI RS, and transmit, to the base station, a CSI report including a channel measurement result of the channel measurement, wherein the channel measurement result is associated with at least one frequency unit among the plurality of frequency units.

A base station in a wireless communication system is provided. The base station comprises a transceiver and a controller coupled with the transceiver and configured to transmit, to a user equipment (UE), configuration information including information on a plurality of frequency units of a channel state information (CSI) reference signal (RS), transmit, to the UE, the CSI RS for a channel measurement associated with the plurality of frequency units of the CSI RS, and receive, from the UE, a CSI report including a channel measurement result of the channel measurement, wherein the channel measurement result is associated with at least one frequency unit among the plurality of frequency units.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIG. 2 illustrates an example base station according to an embodiment of the disclosure;

FIG. 3 illustrates an example user equipment according to an embodiment of the disclosure;

FIG. 4 illustrates a schematic diagram of a Joint Phased and Timed Array (JPTA) codebook, according to an embodiment of the disclosure;

FIG. 5 illustrates an example of at least one time unit and at least one frequency unit of a first reference signal block, according to an embodiment of the disclosure;

FIG. 6 illustrates a schematic diagram of frequency unit positions of a first reference signal block in different time units according to an embodiment of the disclosure;

FIG. 7 illustrates a flowchart of a method performed by a terminal according to an embodiment of the disclosure;

FIG. 8A illustrates a flowchart of a method performed by a base station according to an embodiment of the disclosure;

FIG. 8B illustrates a schematic diagram of a reference wide beam and an auxiliary wide beam according to an embodiment of the disclosure;

FIG. 9 illustrates a block diagram of a first node according to an embodiment of the disclosure; and

FIG. 10 illustrates a block diagram of a second node according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Furthermore, in the description of the example embodiments of the disclosure, “/” means “and/or.” For example, “A/B” may mean A and/or B.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as read-only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first,” “second” and similar words used in the disclosure do not express any order, quantity, or importance, but are only used to distinguish different components. Similar words such as singular forms “a,” “an” or “the” do not express a limitation of quantity, but express the existence of at least one of the referenced items, unless the context clearly dictates otherwise. For example, reference to “a component surface” includes reference to one or more of such surfaces.

As used herein, any reference to “an example” or “example,” “an implementation” or “implementation,” “an embodiment” or “embodiment” means that particular elements, features, structures, or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” may mean one or more. Accordingly, a set of items may be a single item or a collection of two or more items.

In the disclosure, to determine whether a specific condition is satisfied or fulfilled, expressions, such as “greater than/larger than” or “less than/smaller than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper,” “lower,” “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies.

Hereinafter, the embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In accordance with some aspects of the disclosure, a method performed by a terminal in a wireless communication system is provided. The method includes: receiving information related to a reference signal, wherein the information related to the reference signal includes first information regarding a plurality of frequency units of the reference signal that are associated with beam management; performing channel measurement based on the plurality of frequency units of the reference signal; and transmitting a channel state information (CSI) report, wherein the CSI report includes at least one of a channel measurement result of the channel measurement associated with at least one frequency unit of the plurality of frequency units or information associated with the at least one frequency unit.

In connection with one or more aspects of the method performed by the terminal described above, for example, the information related to the reference signal further includes second information regarding a plurality of time units of the reference signal.

In connection with one or more aspects of the method performed by the terminal described above, for example, the CSI report further includes information regarding a time unit corresponding to the at least one frequency unit.

In connection with one or more aspects of the method performed by the terminal described above, for example, the at least one frequency unit of the plurality of frequency units includes at least one of: a frequency unit with the best channel measurement result of the plurality of frequency units; or M frequency units with the top M best channel measurement results of the plurality of frequency units, where M is a positive integer.

In connection with one or more aspects of the method performed by the terminal described above, for example, the receiving of the information related to the reference signal includes receiving the information related to the reference signal via at least one of higher layer signaling or downlink control information (DCI), wherein the higher layer signaling includes at least one of radio resource control (RRC) signaling or a medium access control (MAC) control element (CE).

In connection with one or more aspects of the method performed by the terminal described above, for example, the receiving of the information related to the reference signal includes: receiving the information related to the reference signal via cell specific higher layer signaling; or receiving the information related to the reference signal via UE-group specific higher layer signaling; or receiving the information related to the reference signal via higher layer signaling that is carried by a downlink shared channel scrambled by a first radio network temporary identifier (RNTI), wherein the first RNTI is associated with the reference signal.

In connection with one or more aspects of the method performed by the terminal described above, for example, the DCI is scrambled by a second RNTI that is associated with the reference signal and is common to a group of users.

In connection with one or more aspects of the method performed by the terminal described above, for example, different time units of the plurality of time units correspond to a same frequency unit.

In connection with one or more aspects of the method performed by the terminal described above, for example, the first information includes information regarding a number of frequency units, wherein the plurality of frequency units are determined by uniformly dividing the predetermined band based on the number of the frequency units.

In connection with one or more aspects of the method performed by the terminal described above, for example, the predetermined band includes a system bandwidth, a bandwidth part (BWP), or a configured bandwidth range.

In connection with one or more aspects of the method performed by the terminal described above, for example, the first information includes information regarding a frequency domain position of each of the plurality of frequency units.

In connection with one or more aspects of the method performed by the terminal described above, for example, positions of frequency units corresponding to different time units of the plurality of time units are different.

In connection with one or more aspects of the method performed by the terminal described above, for example, the first information includes a frequency hopping pattern indicating a position of a frequency unit corresponding to each of the time units.

In connection with one or more aspects of the method performed by the terminal described above, for example, a number of frequency units corresponding to each of the time units of the reference signal is the same; and/or a bandwidth of the frequency units corresponding to each of the time units of the reference signal is the same.

In connection with one or more aspects of the method performed by the terminal described above, for example, wherein the second information includes information regarding one or more time unit groups, each of the time unit groups including at least one time unit that is consecutive in time domain, wherein positions of frequency units corresponding to different time unit groups of the reference signal are different.

In connection with one or more aspects of the method performed by the terminal described above, for example, the plurality of frequency units of the reference signal are determined based on a predefined or configured frequency hopping pattern of the reference signal, wherein the frequency hopping pattern of the reference signal indicates positions of frequency units in each of the time unit groups of the reference signal.

In connection with one or more aspects of the method performed by the terminal described above, for example, positions of frequency units of the reference signal in each of the time units of the time unit group are the same; a number of frequency units of the reference signal in each of the time units of the time unit group is the same; and/or a frequency domain spacing of adjacent frequency units of the reference signal in different time unit groups is the same.

In connection with one or more aspects of the method performed by the terminal described above, for example, the information related to the reference signal further includes information indicating a quasi co-location (QCL) relationship of the reference signal in different frequency units in the same time unit.

In connection with one or more aspects of the method performed by the terminal described above, for example, the frequency unit includes at least one of: a frequency subband; a frequency subband associated with Joint Phased and Timed Array (JPTA) beamforming; a physical resource block group (RBG); or a bandwidth part (BWP).

In connection with one or more aspects of the method performed by the terminal described above, for example, the time unit includes at least one of one or more radio frames, one or more subframes, one or more slots, or one or more symbols.

In connection with one or more aspects of the method performed by the terminal described above, for example, the reference signal is transmitted by the base station using JPTA beamforming.

In connection with one or more aspects of the method performed by the terminal described above, for example, the reference signal is transmitted on wide beams on multiple frequency subbands, wherein the directions of the wide beams partially overlap. For example, the frequency subbands are associated with JPTA.

In connection with one or more aspects of the method performed by the terminal described above, for example, the partially overlapping wide beams include a reference wide beam. For example, the partially overlapping wide beams also include one or more auxiliary wide beams.

In connection with one or more aspects of the method performed by the terminal described above, the measurement result includes at least one of the following: signal-to-noise ratio (SNR), signal-to-interference-plus-noise ratio (SINR), reference signal reception power (RSRP), and channel quality indicator (CQI).

In connection with one or more aspects of the method performed by the terminal described above, for example, the reference signal includes at least one of: a synchronization signal block (SSB); or a channel state information reference signal (CSI-RS).

In connection with one or more aspects of the method performed by the terminal described above, for example, the transmitting of the CSI report includes transmitting the CSI report to a base station for the base station to schedule based on the at least one of the channel measurement result associated with at least one frequency unit or the information associated with the at least one frequency unit.

In accordance with some aspects of the disclosure, a method performed by a base station in a wireless communication system is provided. The method includes: transmitting information related to a reference signal to a terminal, wherein the information related to the reference signal includes first information regarding a plurality of frequency units of the reference signal that are associated with beam management; and receiving a channel state information (CSI) report from the terminal, wherein the CSI report is based on channel measurement on the plurality of frequency units of the reference signal, wherein the CSI report includes at least one of a channel measurement result of the channel measurement associated with at least one frequency unit of the plurality of frequency units or information associated with the at least one frequency unit.

In connection with one or more aspects of the method performed by the base station described above, for example, the information related to the reference signal further includes second information regarding a plurality of time units of the reference signal.

In connection with one or more aspects of the method performed by a base station described above, for example, the CSI report further includes information regarding time units corresponding to the at least one frequency unit.

In connection with one or more aspects of the method performed by the base station described above, for example, the at least one frequency unit of the plurality of frequency units includes at least one of: a frequency unit with the best channel measurement result of the plurality of frequency units; or M frequency units with the top M best channel measurement results of the plurality of frequency units, where M is a positive integer.

In connection with one or more aspects of the method performed by the base station described above, for example, the transmitting of the information related to the reference signal includes transmitting the information related to the reference signal via at least one of higher layer signaling or downlink control information (DCI), wherein the higher layer signaling includes at least one of radio resource control (RRC) signaling or a medium access control (MAC) control element (CE).

In connection with one or more aspects of the method performed by the base station described above, for example, the transmitting of the information related to the reference signal includes: transmitting the information related to the reference signal via cell specific higher layer signaling; or transmitting the information related to the reference signal via UE-group specific higher layer signaling; or transmitting the information related to the reference signal via higher layer signaling that is carried by a downlink shared channel scrambled by a first radio network temporary identifier (RNTI), wherein the first RNTI is associated with the reference signal.

In connection with one or more aspects of the method performed by the base station described above, for example, the DCI is scrambled by a second RNTI that is associated with the reference signal and is common to a group of users.

In connection with one or more aspects of the method performed by the base station described above, for example, different time units of the plurality of time units correspond to a same frequency unit.

In connection with one or more aspects of the method performed by the base station described above, for example, the plurality of frequency units of the reference signal are located within a predetermined band and are contiguous.

In connection with one or more aspects of the method performed by the base station described above, for example, the first information includes information regarding a number of frequency units, wherein the plurality of frequency units are determined by uniformly dividing the predetermined band based on the number of the frequency units.

In connection with one or more aspects of the method performed by the base station described above, for example, the predetermined band includes a system bandwidth, a bandwidth part (BWP), or a configured bandwidth range.

In connection with one or more aspects of the method performed by the base station described above, for example, the first information includes information regarding a frequency domain position of each of the plurality of frequency units.

In connection with one or more aspects of the method performed by the base station described above, for example, different time units correspond to different positions of frequency units.

In connection with one or more aspects of the method performed by the base station described above, for example, the first information includes a frequency hopping pattern indicating a position of a frequency unit corresponding to each of the time units.

In connection with one or more aspects of the method performed by the base station described above, for example, a number of frequency units corresponding to each of the time units of the reference signal is the same; and/or a bandwidth of the frequency units corresponding to each of the time units of the reference signal is the same.

In connection with one or more aspects of the method performed by the base station described above, for example, the second information includes information regarding one or more time unit groups, each of the time unit groups including at least one time unit that is consecutive in time domain, wherein positions of frequency units corresponding to different time unit groups of the reference signal are different.

In connection with one or more aspects of the method performed by the base station described above, for example, the plurality of frequency units of the reference signal are determined based on a predefined or configured frequency hopping pattern of the reference signal, wherein the frequency hopping pattern of the reference signal indicates positions of frequency units in each of the time unit groups of the reference signal.

In connection with one or more aspects of the method performed by the base station described above, for example, positions of frequency units of the reference signal in each of the time units of the time unit group are the same; a number of frequency units of the reference signal in each of the time units of the time unit group is the same; and/or a frequency domain spacing of adjacent frequency units of the reference signal in different time unit groups is the same.

In connection with one or more aspects of the method performed by the base station described above, for example, the information related to the reference signal further includes information indicating a quasi co-location (QCL) relationship of the reference signal in different frequency units in the same time unit.

In connection with one or more aspects of the method performed by the base station described above, for example, the frequency unit includes at least one of: a frequency subband; a frequency subband associated with Joint Phased and Timed Array (JPTA) beamforming; a physical resource block group (RBG); or a bandwidth part (BWP).

In connection with one or more aspects of the method performed by a base station described above, for example, the time unit includes at least one of one or more radio frames, one or more subframes, one or more slots, or one or more symbols.

In connection with one or more aspects of the method performed by a base station described above, for example, the method further includes transmitting the reference signal using JPTA beamforming.

In connection with one or more aspects of the method performed by the base station described above, for example, the reference signal is transmitted on wide beams on multiple frequency subbands, wherein the wide beams partially overlap in angular domain. For example, the frequency subbands are associated with JPTA.

In connection with one or more aspects of the method performed by the base station described above, for example, the partially overlapping wide beams include a reference wide beam. For example, the partially overlapping wide beams also include one or more auxiliary wide beams.

In connection with one or more aspects of the method performed by the base station described above, the method further includes that the base station determines a narrow beam for the terminal based on the measurement result for each of the multiple frequency subbands. The method further includes that the base station transmits or receives signals to or from the terminal based on the determined narrow beam for the terminal.

In connection with one or more aspects of the method performed by the base station described above, the narrow beam for the terminal is determined based on one or more of the following: determining a ratio of a measurement result of each of one or more auxiliary wide beams to a measurement result of the reference wide beam; determining an arrival angle of the terminal based on the auxiliary wide beam and the ratio; and determining the narrow beam for the terminal based on the determined arrival angle and one or more narrow beams of the base station. For example, the one or more auxiliary wide beams do not overlap in angular domain and are associated with the same reference wide beam.

In connection with one or more aspects of the method performed by the base station described above, the narrow beam for the terminal is determined based on one or more of the following: for each of one or more combinations of a reference wide beam and an auxiliary wide beam, determining a ratio of a measurement result of each auxiliary wide beam in the combination to a measurement result of the reference wide beam in the combination; determining an arrival angle of the terminal based on the auxiliary wide beam and the ratio; and determining the narrow beam for the terminal based on the determined arrival angle and one or more narrow beams of the base station.

In connection with one or more aspects of the method performed by the base station described above, the measurement result includes at least one of the following: signal-to-noise ratio (SNR), signal-to-interference-plus-noise ratio (SINR), reference signal reception power (RSRP), and channel quality indicator (CQI).

In connection with one or more aspects of the method performed by the base station described above, for example, the reference signal includes at least one of: a synchronization signal block (SSB); or a channel state information reference signal (CSI-RS).

In connection with one or more aspects of the method performed by the base station described above, for example, the method further includes performing scheduling based on the at least one of the channel measurement result associated with at least one frequency unit or the information associated with the at least one frequency unit.

In accordance with some aspects of the disclosure, a terminal in a wireless communication system is also provided. The terminal includes a transceiver and one or more processors coupled with the transceiver and configured to perform one or more aspects of the above-described method performed by the terminal.

In accordance with some aspects of the disclosure, a base station in a wireless communication system is also provided. The base station includes a transceiver and one or more processors coupled with the transceiver and configured to perform one or more aspects of the above-described method performed by the base station.

In accordance with some aspects of the disclosure, there is also provided a computer-readable storage medium having stored thereon one or more computer programs that, when executed by one or more processors, can implement one or more aspects of the above-described method performed by a terminal.

In accordance with some aspects of the disclosure, there is also provided a computer-readable storage medium having stored thereon one or more computer programs that, when executed by one or more processors, can implement one or more aspects of the above-described method performed by a base station.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

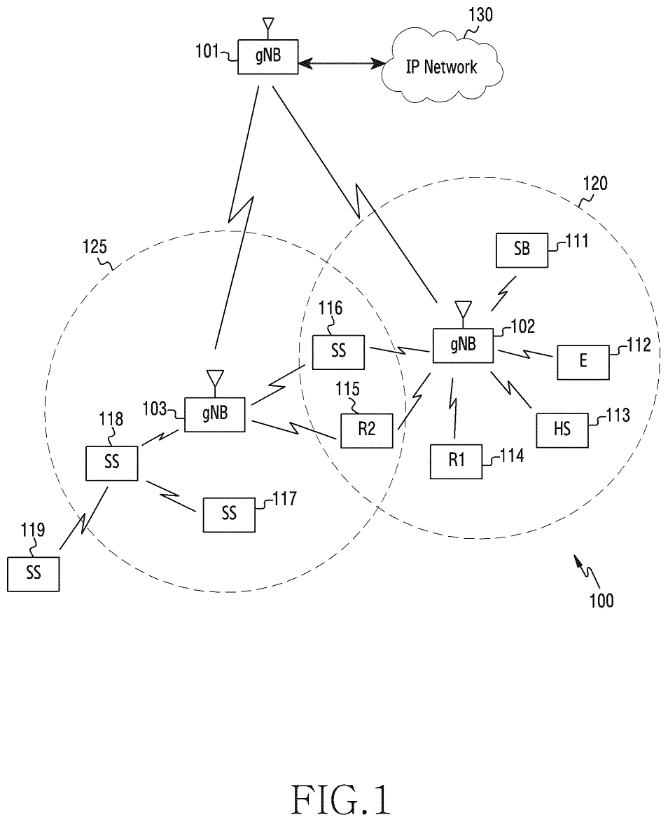

FIGS. 1 to 3 below describe various embodiments of the disclosure implemented in wireless communications systems. The descriptions of FIGS. 1 to 3 are not meant to imply physical or architectural limitations to the manner in which different embodiments may be implemented. Different embodiments of the disclosure may be implemented in any suitably-arranged communications system.

FIG. 1 illustrates an example wireless network according to an embodiment of the disclosure. The embodiment of the wireless network shown in FIG. 1 is for illustration only. Other embodiments of the wireless network 100 could be used without departing from the scope of the disclosure.

Referring to FIG. 1, the wireless network includes a base station (next generation nodeB, gNB or gNodeB) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R1); a UE 115, which may be located in a second residence (R2); and a UE 116, which may be a mobile device (M), such as a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116, as well as subscriber stations (SS, for example, UEs) 117, 118 and 119. In some embodiments, one or more of the gNBs 101-103 may communicate with each other and with the UEs 111-116 using existing wireless communication techniques, and one or more of the UE 111-119 may communicate directly with each other (e.g., UEs 117-119) using other existing or proposed wireless communication techniques.

Depending on the network type, the term “base station” or “BS” can refer to any component (or collection of components) configured to provide wireless access to a network, such as transmit point (TP), transmit-receive point (TRP), an enhanced (or “evolved”) base station (eNodeB or eNB), a 5G base station (gNB), a macrocell, a femtocell, a wireless fidelity (WiFi) access point (AP), or other wirelessly enabled devices. Base stations may provide wireless access in accordance with one or more wireless communication protocols, e.g., 3GPP 5G new radio (NR), long term evolution (LTE), LTE advanced (LTE-A), high speed packet access (HSPA), Wi-Fi 802.11a/b/g/n/ac, etc. For the sake of convenience, the various names for a base station-type apparatus and functionality are used interchangeably in this patent document to refer to network infrastructure components that provide wireless access to remote terminals. Also, depending on the network type, the term “user equipment” (UE) can refer to any component such as a mobile station (MS), subscriber station (SS), remote terminal, wireless terminal, receive point, or user device. For the sake of convenience, the various names for a user equipment-type device and functionality are used interchangeably in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-119 include circuitry, programing, or a combination thereof. In certain embodiments, and one or more of the gNBs 101-103 includes circuitry, programing, or a combination thereof.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

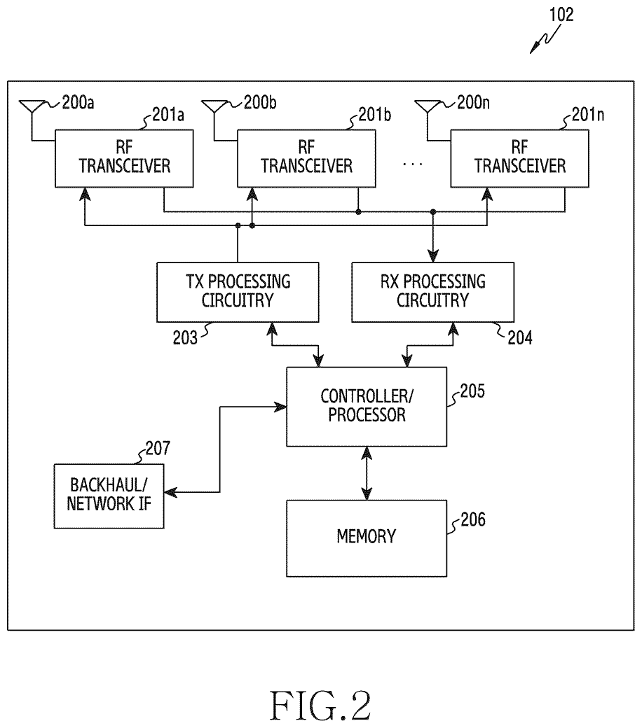

FIG. 2 illustrates an example base station according to an embodiment of the disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the disclosure to any particular implementation of a gNB.

Referring to FIG. 2, the gNB 102 includes multiple antennas 200a, 200b, . . . , 200n, multiple radio frequency (RF) transceivers 201a, 201b, . . . , 201n, transmit (TX) processing circuitry 203, and receive (RX) processing circuitry 204. The gNB 102 also includes a controller/processor 205, a memory 206, and a backhaul or network interface 207.

The RF transceivers 201a, 201b, . . . , 201n receive, from the antennas 200a, 200b, . . . , 200n, incoming RF signals, such as signals transmitted by UEs in the network 100. The RF transceivers 201a, 201b, . . . , 201n down-convert the incoming RF signals to generate intermediate frequency (IF) or baseband signals. The IF or baseband signals are sent to the RX processing circuitry 204, which generates processed baseband signals by filtering, decoding, and/or digitizing the baseband or IF signals. The RX processing circuitry 204 transmits the processed baseband signals to the controller/processor 205 for further processing.

The TX processing circuitry 203 receives analog or digital data (such as voice data, web data, electronic mail, or interactive video game data) from the controller/processor 205. The TX processing circuitry 203 encodes, multiplexes, and/or digitizes the outgoing baseband data to generate processed baseband or IF signals. The RF transceivers 201a, 201b, . . . , 201n receive the outgoing processed baseband (BB) or IF signals from the TX processing circuitry 203 and up-converts the baseband or IF signals to RF signals that are transmitted via the antennas 200a, 200b, . . . , 200n.

The controller/processor 205 can include one or more processors or other processing devices that control the overall operation of the gNB 102. For example, the controller/processor 205 could control the reception of forward channel signals and the transmission of reverse channel signals by the RF transceivers 201a, 201b, . . . , 201n, the RX processing circuitry 204, and the TX processing circuitry 203 in accordance with well-known principles. The controller/processor 205 could support additional functions as well, such as more advanced wireless communication functions.

For instance, the controller/processor 205 could support beam forming or directional routing operations in which outgoing signals from multiple antennas 200a, 200b, . . . , 200n are weighted differently to effectively steer the outgoing signals in a desired direction. Any of a wide variety of other functions could be supported in the gNB 102 by the controller/processor 205.

The controller/processor 205 is also capable of executing programs and other processes resident in the memory 206, such as an operating system (OS). The controller/processor 205 can move data into or out of the memory 206 as required by an executing process.

The controller/processor 205 is also coupled to the backhaul or network interface 207. The backhaul or network interface 207 allows the gNB 102 to communicate with other devices or systems over a backhaul connection or over a network. The interface 207 could support communications over any suitable wired or wireless connection(s). For example, when the gNB 102 is implemented as part of a cellular communication system (such as one supporting 5G, LTE, or LTE-A), the interface 207 could allow the gNB 102 to communicate with other gNBs over a wired or wireless backhaul connection. When the gNB 102 is implemented as an access point, the interface 207 could allow the gNB 102 to communicate over a wired or wireless local area network or over a wired or wireless connection to a larger network (such as the Internet). The interface 207 includes any suitable structure supporting communications over a wired or wireless connection, such as an Ethernet or RF transceiver.

The memory 206 is coupled to the controller/processor 205. Part of the memory 206 could include a random access memory (RAM), and another part of the memory 206 could include a flash memory or other read only memory (ROM).

Although FIG. 2 illustrates one example of gNB 102, various changes may be made to FIG. 2. For example, the gNB 102 could include any number of each component shown in FIG. 2. As a particular example, an access point could include a number of interfaces 207, and the controller/processor 205 could support routing functions to route data between different network addresses. As another particular example, while shown as including a single instance of TX processing circuitry 203 and a single instance of RX processing circuitry 204, the gNB 102 could include multiple instances of each (such as one per RF transceiver). Also, various components in FIG. 2 could be combined, further subdivided, or omitted and additional components could be added according to particular needs.

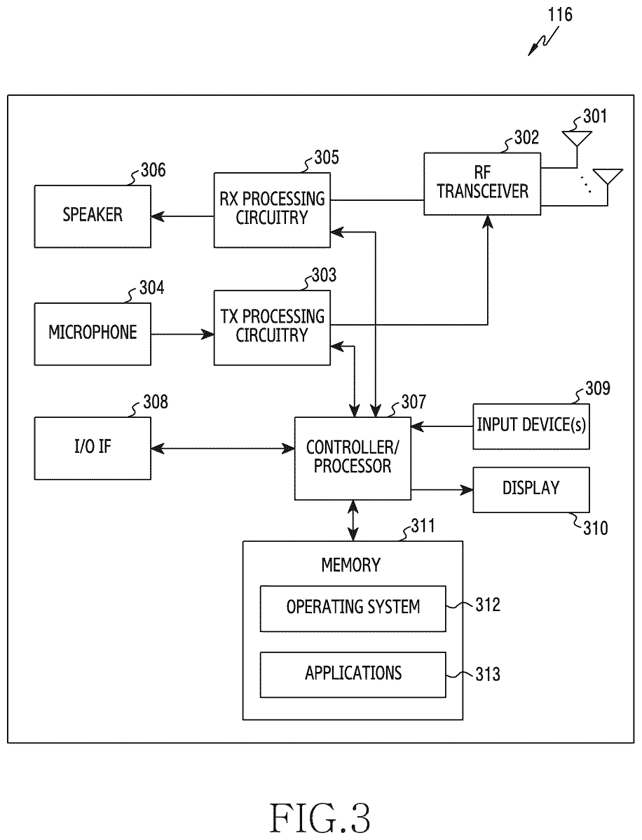

FIG. 3 illustrates an example user equipment according to an embodiment of the disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the disclosure to any particular implementation of a UE.

Referring to FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, an input device 309, a touchscreen display 310, and a memory 311. The memory 311 includes an OS 312 and one or more applications 313.

The RF transceiver 302 receives, from the antenna 301, an incoming RF signal transmitted by a gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 may include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for channel state information (CSI) reporting on uplink channel. The processor 307 can move data into or out of the memory 311 as required by an executing process. In some embodiments, the processor 307 is configured to execute the applications 313 based on the OS 312 or in response to signals received from gNBs or an operator. The processor 307 is also coupled to the I/O interface 308, which provides the UE 116 with the ability to connect to other devices, such as laptop computers and handheld computers. The I/O interface 308 is the communication path between these accessories and the processor 307.

The processor 307 may be also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 may be coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a personal communications service (PCS), which may combine voice, data processing, fax and/or data communication capabilities; a personal digital assistant (PDA), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (mobile internet device) and/or a mobile phone with music/video playing functions, a smart TV, a set-top box, and other devices

Example embodiments of the disclosure provide a method performed by a terminal, a terminal, a method performed by a base station, a base station, and a non-transitory computer-readable storage medium in a communication system.

In describing a wireless communication system and in the disclosure described below, transferring methods (or configuration methods) of higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via radio resource control (RRC) signaling, packet data convergence protocol (PDCP) signaling, or a medium access control (MAC) control element (CE).

In the following description of the example embodiments of the disclosure, higher layer signaling may be signaling corresponding to at least one or a combination of one or more of the following signaling.
master information block (MIB)
system information block (SIB) or SIB X (X=1, 2, . . . )
RRC signaling
MAC CE

Physical layer (Layer 1 (L1)) signaling may be signaling corresponding to at least one or a combination of one or more of the following signaling.
physical downlink control channel (PDCCH)
downlink control information (DCI)
UE-specific DCI
group common DCI
common DCI (e.g., multicast DCI)
scheduling DCI (for example, DCI for scheduling downlink or uplink data)
non-scheduling DCI (for example, DCI other than DCI for scheduling downlink or uplink data)
physical uplink control channel (PUCCH)
uplink control information (UCI)
paging
physical random access channel (PRACH)
random access response (RAR)

According to an embodiment, uplink control signaling may include physical layer signaling and/or higher layer signaling. As described above, the physical layer signaling may include UCI and/or PUCCH, and the higher layer signaling may include RRC signaling and/or a MAC CE.

According to an embodiment, downlink control signaling may include physical layer signaling and/or higher layer signaling. As mentioned above, the physical layer signaling may include one or more of PDCCH, DCI, UE-specific DCI, group common DCI, common DCI, scheduling DCI (e.g., DCI for scheduling downlink or uplink data), non-scheduling DCI, paging, and RAR, and the higher layer signaling may include one or more of a MIB, a SIB or SIB X (X=1, 2, . . . ), RRC signaling or a MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

It should be noted that, unless the context clearly indicates otherwise, all or one or more of the methods, steps or operations described in the example embodiments of the disclosure may be specified by protocols and/or configured by higher layer signaling and/or indicated by dynamic signaling. The dynamic signaling may be a PDCCH and/or DCI and/or a DCI format. For example, a semi-persistent scheduling (SPS) PDSCH and/or configured grant (CG) PUSCH may be dynamically indicated in a corresponding activated DCI/DCI format/PDCCH. All or one or more of the described methods, steps and operations may be optional. For example, in case that a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the example embodiments of the disclosure may be higher layer parameters. For example, the higher layer parameters may be parameters configured or indicated by higher layer signaling (e.g., RRC signaling).

It should be noted that, multiple methods described in the disclosure may be combined in any order. In a combination, a method may be performed one or more times.

It should be noted that, steps/operations of methods of the disclosure may be implemented in any order.

It should be noted that, in the example embodiments of the disclosure, “performing a predefined method (or step) if a predefined condition is satisfied” and “not performing the predefined method (or step) if the predefined condition is not satisfied” may be used interchangeably. “Not performing a predefined method (or step) if a predefined condition is satisfied” and “performing the predefined method (or step) if the predefined condition is not satisfied” may be used interchangeably.

In the description of example embodiments of the disclosure, a resource, which may also be referred to as a physical resource, may include a time domain resource (or time resource) and/or a frequency domain resource (or frequency resource).

In the description of the example embodiments of the disclosure, the term “time domain resource” or “time resource” may refer to or be used interchangeably with at least one of symbol(s) (e.g., OFDM symbols), slot(s), subslot(s), mini-slot(s), or subframe(s).

In the description of the example embodiments of the disclosure, a “time unit” may refer to a unit of a “time domain resource” or a “time resource.”

In the description of the example embodiments of the disclosure, the term “frequency domain resource” or “frequency resource” may refer to or be used interchangeably with at least one of the following: channel(s), subchannel(s), carrier(s), subcarrier(s), resource block(s) (RB), resource element(s) (RE(s)), physical resource block(s) (PRB(s)), or physical resource block group(s) (RBG(s)).

In the description of the example embodiments of the disclosure, a “frequency unit” may refer to a unit of a “frequency domain resource” or a “frequency resource.”

It should be noted that in the description of the example embodiments of the disclosure, the term “beam” may be understood as a transmission configuration indicator (TCI) state/reference signal/channel/spatial relationship; or a TCI state identity (ID)/reference signal ID/channel ID/spatial relationship ID; or a spatial filter associated with a TCI state/reference signal/channel/spatial relationship; or a spatial filter associated with a TCI state ID/reference signal ID/channel ID/spatial relationship ID. In example embodiments of the disclosure, the following descriptions may be used interchangeably:
beam;
spatial filter;
spatial domain filter;
spatial domain transmission filter;
spatial setting;
quasi co-location (QCL) assumption;
QCL parameter (QCL-type (for example, type D (typeD)) parameter/reference signal);
TCI state;
unified TCI state;
spatial relationship;
information related to sounding reference signal (SRS) (for example, SRS resource indication (SRI)).

In the description of the example embodiments of the disclosure, unless the context clearly indicates otherwise, the term “reference signal” may be used interchangeably with the term “reference signal block.” Also, a “reference signal block” may include one or more blocks. One block of a reference signal block may have or correspond to one time unit (or, block index) and one frequency unit (or frequency subband). Accordingly, a reference signal block may include one or more time units and one or more frequency units. As such, block(s) of a reference signal block is (are) associated with “time unit(s)” and “frequency unit(s).”

Hereinafter, various example embodiments of the disclosure will be described in detail with reference to the accompanying drawings.

A communication technology having millimeter-wave technology as a main feature (e.g., 5th generation communication technology), which greatly improves the throughput of a communication network and brings about an increase in user experience, is gradually becoming a main technology for wireless communication worldwide. Since the path loss of wireless transmission in the millimeter-wave band is large, large-scale antenna technology of analog beamforming is introduced in order to guarantee transmission performance, and coverage performance of millimeter-wave communication is guaranteed by increasing antenna gain. The principle of this technique to improve coverage is that by increasing a number of antenna elements in an array and adding a phase shifter to each antenna element, a “narrow” transmit or receive beam can be formed by adjusting the phase of each antenna element. The narrow beam causes the energy of the transmit signal to be more focused in the desired direction of wireless transmission, and thus the coverage capability can be improved. However, this goal is achieved on the premise that a base station and a UE can perform beam pairing. For example, when a base station performs downlink communication with a UE, the base station needs to transmit a downlink signal using a transmit beam that is spatially aligned with the UE, and the UE needs to receive the downlink signal using a receive beam that is spatially aligned with the base station. Notably, for communications in the millimeter wave band, the best beam pair to communicate with the UE by the base station may be unique.

The beam is generated in analog domain by adjusting the phase shifter of each antenna element, which means that the generated beam is a time domain beam, that is, the same antenna panel can only generate one beam at the same time. At this time, the base station can only serve UEs in different beam directions in a time division manner. Therefore, it is difficult to ensure that the same transmit beam or receive beam is used in a continuous period of time, especially when the number of UEs are large and the UEs are in scattered locations. While no continuous time resource is used for repeated transmission of physical signals/channels under the same transmission beam and/or reception beam condition, which is a bottleneck factor hindering further improvement in coverage capability for the millimeter-wave band. It is desirable to employ new antenna technologies to improve this problem of millimeter wave communications. For example, a beamforming approach that enables frequency-division beams may be employed. Examples of such beamforming approach include joint phased and timed array (JPTA). The basic principle of the JPTA is that by adding a delay device in addition to a phase shifter of each antenna element, it is possible to achieve transmission of multiple beams or reception of multiple beams at the same time by adjusting the phase and/or delay of each antenna element, the transmission beams or reception beams being allocated on different and non-overlapping frequency subbands. By using the JPTA, it can support the generation of multiple transmit beams or multiple receive beams at the same time without increasing the antenna panel of the communication device. With this technique, it is possible to ensure that consecutive time resources are allocated to the same beam without interrupting uplink and/or downlink communication of the UE in different beam directions, thereby improving uplink and/or downlink coverage capabilities. The JPTA may be more suitable for base stations in view of the increased cost of the device to add the delay device and the increased hardware size of the device.

How to determine a JPTA beamforming codebook (the beamforming codebook is also referred to as spatial filter parameters, e.g., a time delay and phase of each antenna element in JPTA, etc.) of a base station is a key issue for applying this technique to a practical communication system. That is, the base station needs to determine multiple beam directions for transmission and reception in a same time (each beam direction corresponding to one or more UEs that perform downlink or uplink transmission), and a frequency subband associated with each beam direction (downlink or uplink transmissions of the UEs corresponding to the beam direction are performed on the frequency subband), in order to determine the JPTA codebook in the time.

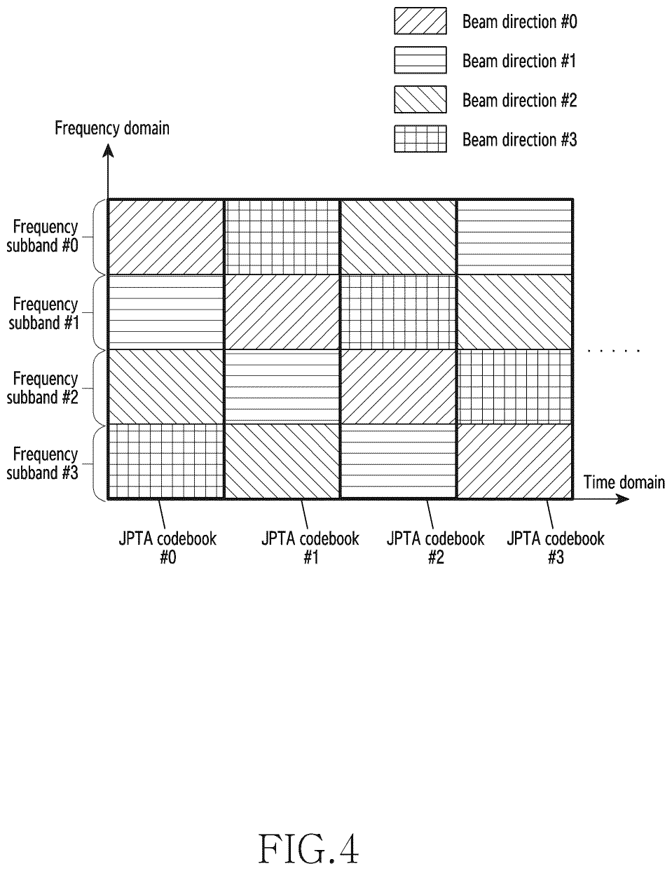

FIG. 4 illustrates a schematic diagram of a JPTA codebook, according to an embodiment of the disclosure. Referring to FIG. 4, assuming that a system bandwidth is uniformly divided into 4 frequency subbands (frequency subbands #0-#3), and there are 4 transmission or reception beam directions (beam directions #0-#3), different JPTA codebooks are generated according to the correspondences of the 4 beam directions to the frequency subbands. According to the one-to-one correspondence of the beam direction and the frequency subband in a same time, the JPTA codebook in the time may be determined. The JPTA codebooks (including a set of beam directions that should be selected, and a frequency subband associated with each beam direction, etc.) determined by the base station should be related to channel state information (CSI) of the served UE that is scheduled in the time by the base station. Accordingly, each UE is required to report beam directions respectively selected on one or more frequency subbands and provide the necessary information for the base station to perform UE scheduling and to calculate the codebook.

In a communication system, a UE may receive a reference signal, and perform channel measurement based on the reference signal, and estimate a channel state based on the channel measurement to obtain channel state information (CSI). The UE may determine (e.g., calculate or derive) a CSI parameter, and transmit a CSI report that includes the CSI parameter. In some embodiments of the disclosure, the reference signal may be illustrated by taking CSI-RS as an example. However, the embodiments of the disclosure are not limited thereto, and the reference signal for measurement may also be other types of reference signals such as a demodulation reference signal (DM-RS) or a phase tracking reference signal (PT-RS). The CSI may include one or more of a channel quality indicator (CQI), a precoding matrix indicator (PMI), a CSI-RS resource indicator (CRI), a synchronization signal (SS)/physical broadcast channel (PBCH) block resource indicator (SSBRI), a layer indicator (LI), a rank indicator (RI), a reference signal receiving power (RSRP), or a signal-to-interference-plus-noise ratio (SINR).

In the related art, the UE may be configured with channel state information reference signal (CSI-RS) resource sets (e.g., for beam management), where each resource set contains one or more CSI-RS resources, where each CSI-RS resource corresponds to one downlink beamforming codebook at the base station side. The UE may report the selected CSI-RS resource index to indicate the selected codebook.

In case that the conventional antenna technology is adopted, one downlink beamforming codebook corresponds to a single downlink beam direction within the system bandwidth. Accordingly, a number of CSI-RS resources for beam management that is configured for the UE adopting the conventional antenna technology is equal to a number of downlink beamforming codebooks of the base station. However, in case that a beamforming approach such as the JPTA is introduced, the UE needs to report not only the selected beamforming codebook, but also the selected frequency subband position or measurement results on different frequency subbands (each frequency subband may correspond to a different beam direction) based on the codebook. In case that the existing beam management method is reused, the number of CSI-RS resources needs to be increased. The required number of CSI-RS resources may be the product of a number of beamforming codebooks of the base station that are configured for UE measurement and a number of divided frequency subbands. As the number of frequency subbands divided by the beamforming approach such as the JPTA increases (e.g., the number of frequency subbands supported by the JPTA may be up to 16), the beamforming approach such as the JPTA would result in a large increase in the number of CSI-RS resources in the existing beam management method, beyond the range that the UE can calculate and maintain, and would also result in an increase in the feedback amount of the CSI report of the UE (since each CSI-RS resource can be independently configured for CSI reporting). Therefore, there is a need for an enhanced CSI reporting method. It should be noted that, for convenience of description, the following example embodiments of the disclosure may be described using the JPTA as an example. However, it should be understood that example embodiments of the disclosure are also applicable to other beamforming approaches like JPTA that can realize frequency division beams.

Example embodiments of the disclosure propose a reference signal and CSI reporting method. For example, the method can effectively reduce a number of reference signal resources (or a number of reference signal resource indexes) required by the UE for CSI measurement reporting for the purpose of beam management (e.g., JPTA beam management), thereby reducing the complexity of the channel measurement by the UE, as well as the feedback amount of reporting.

According to an example embodiment of the disclosure, a method of reference signal and CSI reporting for beam management is proposed. The method may include that the UE receive at least one first reference signal block according to configuration information (e.g., a configuration related to the at least one first reference signal block). The method may further include that the UE reports CSI obtained based on the at least one first reference signal block, where the reported CSI includes at least an indication related to frequency unit(s) (which may simply be referred to as “frequency unit related indication” in example embodiments of the disclosure) of the first reference signal block. For example, the first reference signal block may be a downlink reference signal, e.g., CSI-RS, synchronization signal (SS) block (SSB), or SS/PBCH block, etc., for the purpose of a specific beam management (e.g., JPTA-based beam management, or other beam managements that can realize frequency division beams). The reported CSI may be CSI reported for the purpose of the specific beam management. For example, the meaning of the first reference signal block may refer to at least one of the following: SSBs with different indexes; CSI-RS resources with different indexes in a same set of CSI-RS resources; CSI-RS resources in different sets of CSI-RS resources; different transport blocks (e.g., time-frequency resource blocks, etc.) of the first reference signal corresponding to different beamforming codebooks (e.g., different downlink transmit spatial filter parameters (at the base station side), different downlink transmit beams (at the base station side), different downlink antenna ports (at the base station side), etc.), etc.

According to an embodiment, the UE reports the CSI to the base station for the base station to schedule based on the frequency unit related indication for the first reference signal block.

According to an embodiment, the frequency unit related indication reported by the UE may include at least one of an index of at least one frequency unit associated with the (single) first reference signal block, or a channel quality measurement (e.g., SNR, SINR, RSRP, CQI, etc.) corresponding to at least one frequency unit associated with the (single) first reference signal block. For example, the first reference signal block that the UE is configured to receive may include at least one frequency unit, and the UE may measure based on the first reference signal transmitted on different frequency units, respectively, and report the frequency unit related indication (e.g., an index of a frequency unit with the largest received signal power/SNR/SINR, of the first reference signal block; indexes of M frequency units with the M (the top M) largest received signal power/SNR/SINR, of the first reference signal block (or indexes of frequency units with a greater received signal power/SNR/SINR than a predetermined threshold), where M may be predefined or configured (e.g., by higher layer signaling)). Note that “an index of a frequency unit” may be equally replaced with “a channel quality measurement result corresponding to a frequency unit” in this example. Assuming that the base station transmits the first reference signal block on the at least one frequency unit in a JPTA beamforming manner, the UE reports an indication of one or more frequency units associated with the first reference signal block, which may be used to indicate the UE's selection of a frequency unit/beam direction for the JPTA beamforming codebook. The measurement procedure may be based on the measurement of a single first reference signal block without increasing a number of reference signal blocks.

In the following implementation, in addition to the frequency unit related indication of the first reference signal block, the CSI reported by the UE may include an indication related to time unit(s) of the first reference signal block (which may simply be referred to as “time unit related indication” in example embodiments of the disclosure).

For example, the time unit related indication may include at least one first reference signal block index (e.g., a first reference signal block index with the largest received signal power/SNR/SINR, of the first reference signal block; M′ first reference signal block indexes with the M′ (top M′) largest received signal power/SNR/SINR, of the first reference signal block (or first reference signal block indexes with a greater received signal power/SNR/SINR of the first reference signal block than a predetermined threshold), where M′ may be preset or configured (e.g., by higher layer signaling); a first reference signal block index where a frequency unit of the first reference signal block with the largest received signal power/SNR/SINR is located; first reference signal block indexes where frequency units of the M first reference signal block with the M (top M) largest received signal power/SNR/SINR are located (first reference signal block indexes associated with frequency units of the first reference signal block (first reference signal block indexes where the frequency units are located) with a greater received signal power/SNR/SINR than a predetermined threshold), where M may be preset or configured (e.g., by higher layer signaling)). When multiple first reference signal blocks of different indexes are transmitted with different JPTA beamforming codebooks, the first reference signal blocks can only be transmitted in different time resources since the beamforming codebook involves radio frequency adjustment, as shown in FIG. 4. When the first reference signal block is configured as the first reference signal transmitted using the time-frequency resource of the same JPTA codebook (e.g., in FIG. 4, the time-frequency resource of the corresponding JPTA codebook #i (i=1, . . . , 3) is the time-frequency resource of the first reference signal block of index i), the first reference signal block index (e.g., an index indicating at least one of the multiple first reference signal blocks) reported by the UE can indicate the selected JPTA beamforming codebook.

For example, the time unit related indication reported by the UE may be at least one time unit index associated with the (single) first reference signal block (e.g. the time unit index with the largest received signal power/SNR/SINR, of the first reference signal; M″ time unit indexes with the M″ (top M″) largest received signal power/SNR/SINR, of the first reference signal block (or the time unit indexes for which the received signal power/SNR/SINR of the first reference signal block is greater than a predetermined threshold), where M″ may be predefined or configured (e.g., by higher layer signaling); a time unit index where a frequency unit with the largest received signal power/SNR/SINR is located; time unit indexes of M frequency units with the M (top M) largest received signal power/SNR/SINR, where M may be preset or configured (e.g., by higher layer signaling)). When the same first reference signal block is transmitted in multiple time units (e.g., 4 blocks of the first reference signal block associated with beam direction #0 in FIG. 4 are transmitted in different time units) and different beamforming codebooks are applied in different time units (e.g., referring to FIG. 4, the 4 blocks of the first reference signal block associated with beam direction #0 are transmitted using JPTA codebook #0, JPTA codebook #1, JPTA codebook #2, and JPTA codebook #3, respectively), the UE reports the corresponding time unit index (e.g., the time unit index(es) associated with one or more of the 4 blocks in FIG. 4) to indicate the selected JPTA beamforming codebook(s). This design can reduce the number of first reference signal blocks required for JPTA beam management. As can be seen, the above method can effectively reduce the number of required reference signal resources (or the number of indexes) on the premise of implementing JPTA beam management by designing the first reference signal transmitted in JPTA beamforming and the corresponding CSI reporting content.

According to an embodiment, in the operation of the UE receiving the at least one first reference signal block according to the configuration information, the UE may obtain or determine the configuration related to the first reference signal block via at least one of higher layer signaling, a MAC CE, or downlink control information. Examples of the UE determining the configuration related to the at least one first reference signal block are described below. It is noted that the following examples may be similarly applied to obtain the related configuration of multiple first reference signal blocks.

As a specific example, the UE may obtain the configuration related to the first reference signal block via cell-specific higher layer signaling. For example, the UE may obtain the configuration related to the first reference signal block by receiving a master message block (MIB), a system information block (SIB), a remaining minimum system information (RMSI), a bandwidth part (BWP) configuration (e.g., the higher layer parameter BWP-Downlink).

As another specific example, the UE may receive a downlink shared channel associated with a first radio network temporary identifier (RNTI) (e.g., the downlink shared channel is scrambled by the first RNTI and/or the downlink shared channel is scheduled by downlink control information scrambled by the first RNTI) that carries higher layer signaling and/or a MAC CE including the configuration related to the first reference signal block, where the first RNTI is a RNTI for the configuration of the first reference signal block.

As yet another specific example, the UE may receive a downlink control channel associated with (e.g., scrambled by) a second RNTI that carries downlink control information including the configuration related to the first reference signal block, where the second specific RNTI is a RNTI for the configuration of the first reference signal block. For example, the RNTI for the configuration of the first reference signal block may be common to a group of UEs (i.e., a group of UEs are configured with the RNTI for the reception of the downlink control channel for the configuration of the first reference signal block), and/or a control channel search space corresponding to the RNTI is a common search space.

The specific examples discussed above propose configuring the common configuration information related to the first reference signal block in a cell-specific or UE group-specific configuration method, i.e., where multiple UEs receive a same physical channel transmitted by the base station to obtain the configuration related to the first reference signal block. This design considers that a same beamforming codebook may support different beam directions on frequency subbands using the JPTA beamforming method, and each beam direction may correspond to a different UE, which means that the first reference signal block corresponding to the same JPTA beamforming codebook should be received by different UEs. At this time, compared with the UE-specific configuration method, the cell-specific or UE-group-specific configuration mode can save more resources for the transmission of the configuration signaling.

According to an embodiment, the operation of the UE receiving the at least one first reference signal block according to the configuration information may include that the UE determines at least one time unit and at least one frequency unit of the first reference signal block according to the configuration information. The meaning of the time unit may be at least one of: slot(s), time domain symbol(s) (e.g., OFDM symbols), radio frame(s), subframe(s), etc.

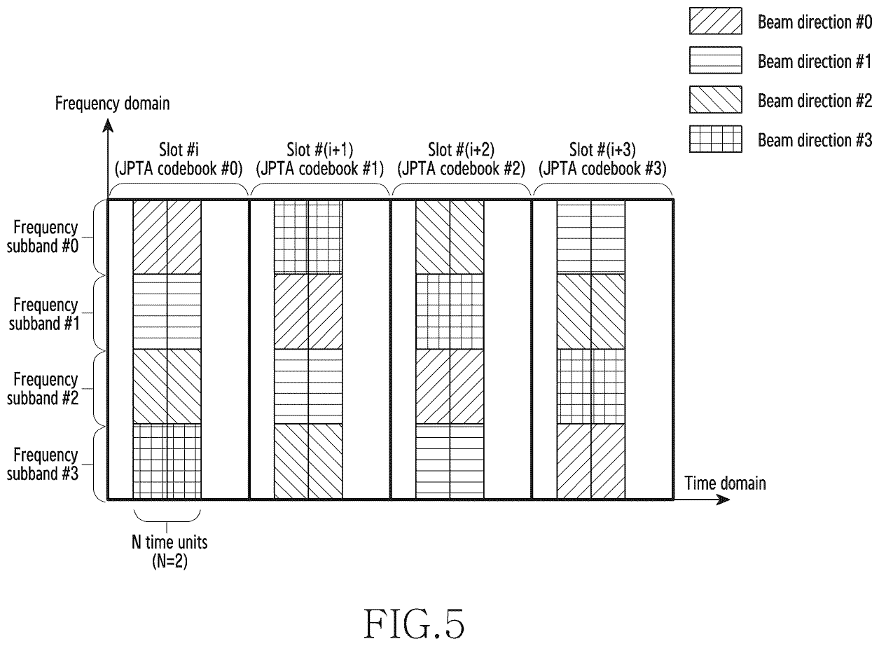

In some examples, the first reference signal block may be transmitted in a basic unit of N consecutive time units (e.g., N symbols) (simply referred to as a basic time unit), where the different basic time units are non-consecutive in time. For example, the first reference signal block is transmitted in basic time units of N time units (each basic time unit may be referred to as a block of the first reference signal block) and any adjacent first reference signal block containing N time units (adjacent blocks of the first reference signal block) are spaced apart by M slots (i.e., the first reference signal blocks are transmitted in an equally spaced manner (e.g., in a periodic manner) of M slots), where N and M are positive integers greater than or equal to 1, which may be configured parameters or parameters fixed by protocols, for example. Additionally or alternatively, for example, N may refer to or be defined as a number of time units of the first reference signal block that are transmitted with a same beamforming codebook/transmit spatial parameter (e.g., spatial filter parameter). The UE may obtain the configuration information regarding N, or the UE may calculate N according to at least one of the following configuration parameters: a number of times Nrep the first reference signal block is repeatedly transmitted with the same transmit spatial parameter (e.g., JPTA beamforming codebook, etc.), a number NAP of antenna ports of the first reference signal block, and a code division manner of the first reference signal block related to antenna ports. For example, N may be determined based on the following formula: N=Nᵣₑₚ×N_{SymPerBeam}, where Nᵣₑₚ is the number of repetitions of the first reference signal block transmitted with the same transmit spatial parameter (e.g., Nᵣₑₚ is 1 in the example of FIG. 5), and N_{SymPerBeam} is a number of time units of a single repetition of the first reference signal block transmitted with the same transmit spatial parameter (e.g., with the same beamforming codebook) (e.g., N_{SymPerBeam} is 2 in the example of FIG. 5). For example, N_{SymPerBeam} may be a configured value or may be determined according to at least one of the number NAP of antenna ports and the code division/mapping manner corresponding to the number of antenna ports, where NAP represents the number of antenna ports for transmitting with the same transmit spatial parameter (e.g., JPTA beamforming codebook, etc.). For example, the number of time units for transmitting using the NAP antenna ports may be determined according to the number of antenna ports and the code division/mapping manner corresponding to the number of antenna ports.

FIG. 5 illustrates an example of at least one time unit and at least one frequency unit of a first reference signal block according to an embodiment of the disclosure, where the first reference signal block is transmitted with N (N=2) consecutive time units as a basic time unit, adjacent basic time units being separated in time by M (M=1) slots. Referring to FIG. 5, the first reference signal block that the UE is configured to receive contains 8 orthogonal frequency division multiplexing (OFDM) symbols that are mapped within the same slot every N (N=2) OFDM symbols (in this example the time unit is an OFDM symbol), and different basic time units (each consisting of N OFDM symbols) are mapped within 4 slots, respectively, where the 4 slots are consecutive in time domain (i.e., different basic time unit s are spaced apart by M (M=1) slot). The same JPTA codebook may be adopted in the slot where the same basic time unit (e.g., consisting of N OFDM symbols) is located (e.g., the same JPTA codebook is adopted in slot #i in FIG. 5), and different slots where different basic time units (e.g., each consisting of N OFDM symbols) are located may adopt different JPTA codebooks (e.g., different JPTA codebooks are adopted in slot #i, slot #(i+1), slot #(i+2), and slot #(i+3) in FIG. 5, i.e., slot #i, slot #(i+1), slot #(i+2), and slot #(i+3) are associated with JPTA codebook #0, JPTA codebook #1, JPTA codebook #2, and JPTA codebook #3, respectively), so as to ensure that the transmit spatial parameter in each time slot is unchanged, and the data transmission on the remaining OFDM symbols in the time slot is not affected.

In some implementations, in the operation of the UE determining the at least one time unit and the at least one frequency unit of the first reference signal block according to the configuration information, the frequency unit may be at least one of: a frequency subband (e.g., a frequency subband associated with JPTA beamforming), a physical resource block group (RBG), a bandwidth part (BWP), etc.

In some examples, numbers of frequency units and positions of the frequency units of the first reference signal block transmissions within different time units of the at least one time unit are the same. For example, the frequency subbands may be frequency subbands that are contiguous in frequency domain and determined (e.g., in a certain manner (e.g., an equally divided manner)) based on the system bandwidth or BWP or configured bandwidth. For example, the UE is configured with a number of frequency subbands of Ns, then the starting frequency of the i-th frequency unit is

$$( i - 1 ) \cdot \frac{B}{Ns}$$

and its ending frequency is

$$i \cdot \frac{B}{Ns} ,$$

where B represents the system bandwidth or BWP or configured bandwidth. Alternatively, in this example, the UE may be configured with a frequency unit bandwidth, i.e.,

$$\frac{B}{Ns} ,$$

and the starting and ending frequencies for each frequency subband may also be calculated based on the formula in the above example.

In other examples, each of the multiple frequency subbands may be separately configured (e.g., independently configured) with a frequency position, e.g., a starting frequency, bandwidth, an ending frequency, etc. In this way, the configuration of frequency subbands that are not equally divided within the system bandwidth or BWP or configured bandwidth can be supported. The reason for introducing the frequency unit configuration is that when the JPTA beamforming technique is employed, the base station can adopt different beam directions on different frequency units in the same time unit, i.e., the transmit spatial parameter of the first reference signal is different on different frequency units, and thus the UE needs to be indicated the positions of the frequency units, and performs the CSI measurement behavior (e.g., calculation of RSRP, SNR, CQI, PMI, etc.) separately on different frequency units. Also, considering the generation mechanism of JPTA beamforming, the generated frequency subbands corresponding to different beam directions should be contiguous in frequency domain over the system bandwidth, and the sizes of the frequency subbands may be or may not be equal to each other.

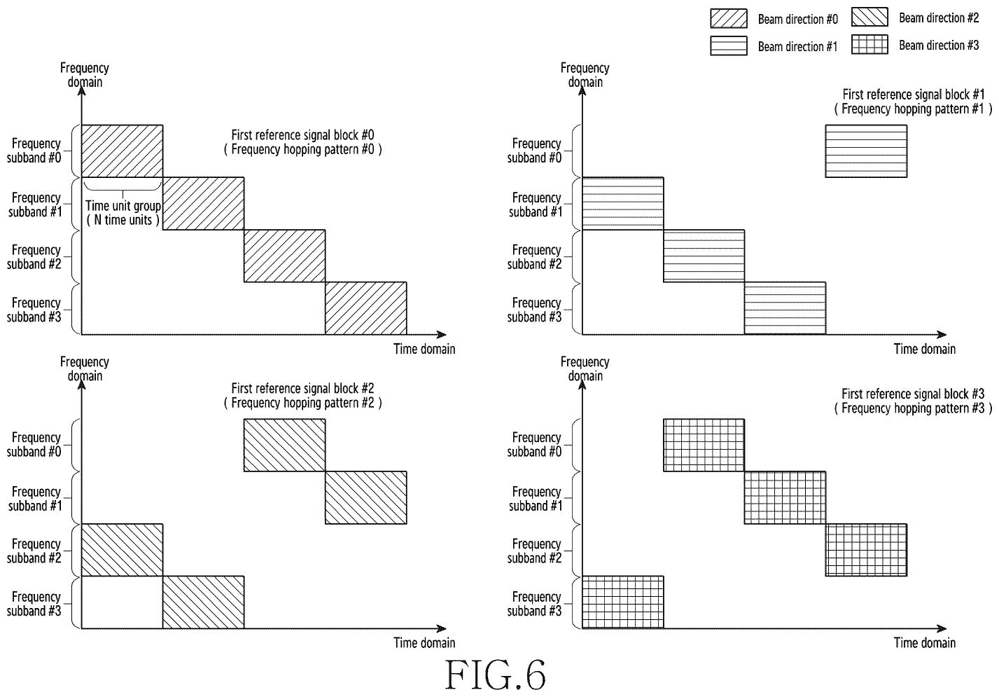

In some examples, in the operation of the UE determining the at least one time unit and the at least one frequency unit of the first reference signal block according to the configuration information, the positions of the frequency units in which the first reference signal block is transmitted in different time units are different. Herein, the manner in which the UE determines the frequency unit positions in different time units may be that the frequency unit positions in different time units are determined (e.g., indicated) according to a predefined or configured resource pattern (e.g., frequency hopping pattern) of the first reference signal, where the resource pattern (e.g., frequency hopping pattern) is used to determine, for each time unit of the first reference signal block, the frequency unit positions of the first reference signal block (the frequency unit positions for the transmission of the first reference signal block) in the time unit. Depending on whether the time units to which the UE is allocated are consecutive or non-consecutive in time domain, the frequency hopping pattern may be used to determine (e.g., indicate) the frequency unit positions in the consecutive or non-consecutive time units. As some examples, the frequency unit positions in the at least one time unit obtained by the UE according to the frequency hopping pattern may have the following characteristics: a bandwidth and/or a number of frequency units for transmission of the first reference signal block is the same in all time units; and/or, in case that the first reference signal block includes one or more time unit groups (e.g., each time unit group may consist of N (N is an integer equal to or greater than 1) time units; the time units in the same time unit group are consecutive in time domain, there is a predefined or configured time spacing between different time unit groups, etc.), the frequency unit position for transmission of the first reference signal block in the time unit group is the same (e.g., the frequency unit position of each time unit of the same time unit group is the same), and/or the frequency domain spacings of adjacent frequency units in different time unit groups are equal (for example, in FIG. 6 which will be described below, first reference signal block #0 includes four time unit groups in time domain (the first time unit group to the fourth time unit group in time order, respectively), the first reference signal block in the first time unit group to the fourth time unit group occupies frequency subband #0 to frequency subband #3, respectively, and the frequency domain spacings of adjacent frequency units (for example, the index differences of the adjacent frequency subbands are the same; for example, the index difference between frequency subband #0 and frequency subband #1, the index difference between frequency subband #1 and frequency subband #2, and the index difference between frequency subband #1 and frequency subband #2 are 1). For example, the frequency unit starting frequency position of the i-th time unit group may be mod (f₀+(i−1)*b_{FH}, B−b_{sub}), where f₀ represents the starting frequency position of the frequency unit hopping of the first reference signal block; b_{FH} represents a frequency hopping interval; b_{sub} represents a frequency subband bandwidth; B represents the system bandwidth or BWP or configured bandwidth range; “mod” represents a modulo operation. In this way, it can be ensured that the frequency subbands after frequency hopping are still within the system bandwidth range (or BWP or configured bandwidth range). f₀, b_{FH}, b_{sub}, and B may each be a configured value or a value fixed by protocols. An example of the frequency unit position of the first reference signal block is described below in connection with FIG. 6.

FIG. 6 illustrates a schematic diagram of frequency unit positions of a first reference signal block in different time units, according to an embodiment of the disclosure.

Referring to FIG. 6, different first reference signal blocks (e.g., first reference signal blocks #0-#3) may be configured with different starting frequencies f₀ for frequency hopping such that frequency subbands of different frequency hopping patterns/first reference signal blocks (e.g., first reference signal blocks #0-#3/hopping patterns #0-#3) in the same time unit are different (e.g., first reference signal block #0 is in frequency subband #0 of the first time unit group, first reference signal block #1 is in frequency subband #1 of the first time unit group, first reference signal block #2 is in frequency subband #2 of the first time unit group, and first reference signal block #3 is in frequency subband #3 of the first time unit group).

At this time, the first reference signal block transmitted by the base station in the JPTA beamforming manner is shown in FIG. 4. That is, the first reference signal is transmitted in four different beam directions (beam directions #0-#3) on frequency subbands #0-#3, respectively. For different beam directions, different first reference signal blocks (first reference signal blocks #0-#3) may be defined based on the method of the hopping configuration of frequency subbands as discussed above. A single UE may only be configured with the first reference signal block corresponding to a beam direction associated with the UE (e.g., a transmit beam direction in which the UE may receive). This method simplifies the processing complexity of the UE by reducing the configuration information for the UE so that the UE does not have to consider receiving first reference signal blocks transmitted in different beam directions. Also, this method can be used to support simultaneous channel state measurements by multiple users. For example, first reference signal blocks #0-#3 may be allocated to 4 UEs, respectively, where the transmission beam direction of each first reference signal block corresponds to a different UE. Preferably, the manner in which the user is configured with the above-mentioned first reference signal block with frequency hopping may be that the user is configured with the first reference signal block via user-specific signaling, e.g., user-specific higher layer signaling, and/or downlink control information, and/or MAC CE, and/or the like.

According to an embodiment, the operation of the UE receiving at least one first reference signal block according to the configuration information may include that the UE determine a quasi co-location relationship of the first reference signal block transmitted on different frequency units in a same time unit included in the first reference signal block (as an example, a quasi co-location relationship of the first reference signal transmissions on respective frequency subbands in each time unit group of the first reference signal block in FIG. 5 (e.g., a quasi co-location relationship of the first reference signal block transmissions on frequency subbands #0-#3 in a same time unit or time unit group in time slots (e.g., each of slots #i-#(i+3) of FIG. 5)); as another example, a quasi co-location relationship of (e.g., different) first reference signal block transmissions on respective frequency subbands in a same time unit group in FIG. 6 (e.g., a quasi co-location relationship of first reference signal block transmissions on frequency subbands #0-#3 (e.g., first reference signal block #0-#3 transmissions) in the first time unit group of FIG. 6)). For example, the UE may determine (e.g., the UE may be configured or it may be fixed protocols) that the quasi co-location relationship is for the same spatial receive parameter (e.g., QCL typeD, same receive beam, same antenna port, etc.). This design allows the UE to simultaneously measure the first reference signal block from different downlink transmit beam directions (of the base station) with the same downlink receive beam on different frequency units within the same time unit, e.g., where the first reference signal block may be transmitted by the base station using JPTA beamforming. In this way, the number of time units of the first reference signal block required for downlink beam refinement can be reduced.

According to an embodiment, the operation of the UE receiving the at least one first reference signal block according to the configuration information may include that the UE determines a quasi co-location related configuration of the first reference signal block transmitted on each frequency unit in a same time unit within the first reference signal blocks. For example, the meaning of the quasi co-location related configuration is that the transmitted first reference signal block on each frequency unit within the same time unit has the same channel state parameters as at least one of the following channel state parameters associated with the assigned downlink reference signal: spatial reception parameters (e.g., QCL typeD, same receive beam, same antenna port, etc.), small scale channel parameters (e.g., doppler shift, doppler delay, average delay, delay spread, channel estimation results, etc.), large scale channel parameters (e.g., path loss, shadowing, etc.). Also, the manner in which the downlink reference signal is specified may be that the downlink reference signal is obtained by configuration parameters (e.g., including SSB index, CSI-RS index, or other downlink reference signal index in the quasi co-location related configuration of each frequency unit, etc.). The quasi co-location related configurations corresponding to different frequency units differ in at least one of the following: the specified downlink reference signal, and the channel state parameter type for the specified downlink reference signal. This design may allow the UE to receive and measure the first reference signal transmitted by the base station in different transmit beams, by using different receive beams (of the UE), respectively. In this case, the first reference signal may be transmitted by the base station in a JPTA beamforming manner, which can make the first reference signal available for beam switching related measurements of the UE, and can also reduce the number of time units of the first reference signal block to some extent, especially when the UE supports receiving the first reference signal with multiple receive beams in the same time unit.

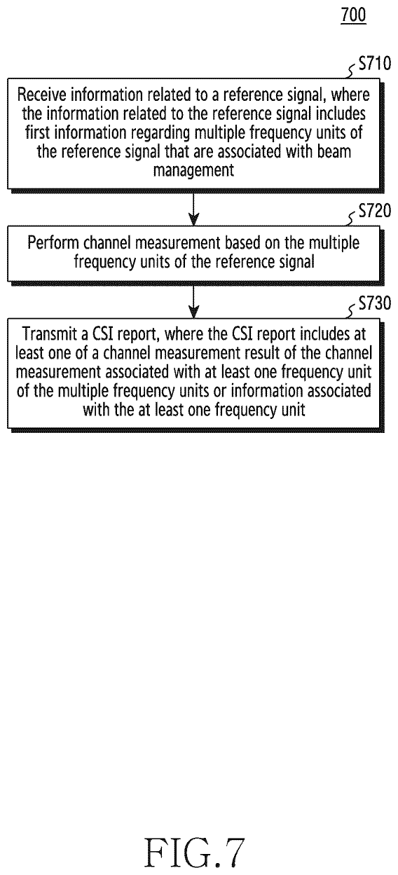

FIG. 7 illustrates a flowchart of a method 700 performed by a terminal according to an embodiment of the disclosure.

Referring to FIG. 7, in operation S710, the terminal receives information related to a reference signal (e.g., the first reference signal block in the example embodiments of the disclosure), where the information related to the reference signal includes first information regarding multiple frequency units of the reference signal that are associated with beam management. For example, the terminal may receive the information related to the reference signal from the base station.

In operation S720, the terminal performs channel measurement based on the multiple frequency units of the reference signal.

In operation S730, the terminal transmits a CSI report, where the CSI report includes at least one of a channel measurement result of the channel measurement associated with at least one frequency unit of the multiple frequency units or information associated with the at least one frequency unit. For example, the terminal may transmit the CSI report to the base station.

In some implementations, one or more of operations S710 to S730 may be performed based on the methods described according to various example embodiments of the disclosure (e.g., example embodiments described in connection with FIGS. 1 to 6).

In some implementations, the method 700 may omit one or more of operations S710 to S730, or may include additional operations, for example, operations that may be performed by a terminal (e.g., a UE) as described in accordance with various example embodiments of the disclosure (e.g., example embodiments described in connection with FIGS. 1 to 6).

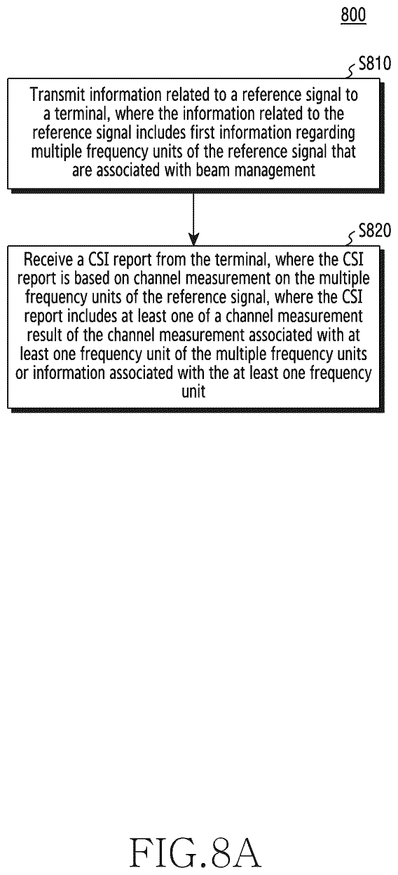

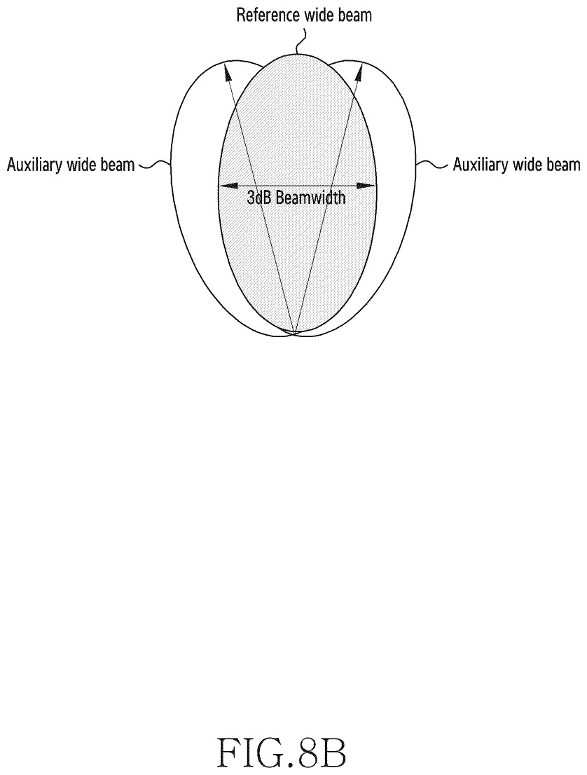

FIG. 8A illustrate a flowchart of a method 800 performed by a base station according to an embodiment of the disclosure.

Referring to FIG. 8A, in operation S810, the base station transmits information related to a reference signal to a terminal, where the information related to the reference signal includes first information regarding multiple frequency units of the reference signal that are associated with beam management.

Next, in operation S820, the base station receives a CSI report from the terminal, where the CSI report is based on channel measurement on the multiple frequency units of the reference signal, where the CSI report includes at least one of a channel measurement result of the channel measurement associated with at least one frequency unit of the multiple frequency units or information associated with the at least one frequency unit.

In some implementations, one or more of S810 to operation S820 may be performed based on the methods described according to various embodiments of the disclosure (e.g., the embodiments described in connection with FIGS. 1 to 6).

In some implementations, the method 800 may omit one or more of operations S810 to S820, or may include additional operations, such as operations that may be performed by an implementation as described in accordance with various embodiments of the disclosure (e.g., exemplary described in connection with FIGS. 1 to 6).

According to an embodiment, beam management may be based on JPTA technology. For example, the beam management process may be simplified by adopting JPTA technology. As an example, the base station may adopt JPTA technology to transmit wide beams in multiple frequency subbands, where the wide beams partially overlap in angular domain. Here, the partially overlapped wide beam may include a reference wide beam, and the corresponding frequency subband may be a reference subband; and/or may include one or more auxiliary wide beams, and the corresponding subbands may be auxiliary subbands.

FIG. 8B illustrates a schematic diagram of a reference wide beam and an auxiliary wide beam according to an embodiment of the disclosure.

As an example, the direction of the reference wide beam may be the beam sweeping reference direction; two or more wide beams adjacent to the reference wide beam may be used as auxiliary wide beams. For example, the probing angle of the auxiliary wide beam is within a certain range of the beamwidth (for example, 3 dB beamwidth) of the reference wide beam, as shown in FIG. 8B.

Meanwhile, the base station may configure CSI-RS measurement resources by adopting the configuration method of CSI-RS according to the example embodiments of the disclosure (the configuration method of CSI-RS) on the frequency subband(s). The terminal may measure on the configured CSI-RS measurement resources and feed back the measurement results of several configured frequency subbands. The measurement result may be, for example, SNR, SINR, RSRP, CQI, etc.

After receiving the measurement results of each subband fed back by the terminal, the base station may determine/know the narrow beam index for the terminal by one or more of the following steps.

The base station may determine the auxiliary wide beam used. For example, the base station may compare the corresponding measurement result of each auxiliary subband and select the auxiliary subband with the best measurement result (for example, the largest RSRP) for the calculation of the arrival angle.

The base station may determine the measurement result ratio (for example, RSRP ratio). The measurement result ratio may be the ratio of the measurement result (for example, RSRP) of the selected auxiliary subband to the measurement result (for example, RSRP) of the reference subband fed back by the terminal.

The base station may determine the arrival angle of the terminal. For example, according to the auxiliary beam direction indicated by the auxiliary subband used to calculate the measurement result ratio and the measurement result ratio (for example, RSRP ratio), the deviation between the arrival angle of the terminal and the reference wide beam direction is obtained (for example, with look-up table), so as to obtain the arrival angle of the terminal.

The base station may determine the narrow beam. According to the arrival angle of the terminal obtained above and the narrow beam direction at the base station side, the narrow beam index for serving the terminal is determined. The base station may use the narrow beam to receive data from or transmit data to the terminal in subsequent transmission.

According to an embodiment, the base station may use two sets of auxiliary wide beams and the corresponding auxiliary subbands to determine/know the horizontal arrival angle and vertical arrival angle of the terminal, respectively. For example, the two sets of auxiliary wide beams may not overlap in angular domain and share the same reference wide beam.

After receiving the feedback information from the terminal, the base station may determine and/or know the horizontal arrival angle of the terminal by using the reference wide beam and the horizontal auxiliary subband (for example, by using the above method); the vertical arrival angle of the terminal is determined/known by using the reference wide beam and the vertical auxiliary subband (for example, by using the above method).

The base station determines/knows the vertical and horizontal arrival angles of the terminal, which may better determine the narrow beam required by the terminal, thus obtaining better performance.

According to an embodiment, the base station may use the combination of two or more sets of reference wide beams and auxiliary beams to increase the measurement range in the angle domain. For example, the different combinations of reference wide beams and auxiliary beams may overlap, that is, a reference wide beam in one combination may be auxiliary beams in other combinations.

In this configuration mode, the receiving method of the base station is as follows.

The base station compares the measurement results (for example, RSRP) fed back for frequency subbands corresponding to different reference wide beams, and obtains the optimal measurement result (for example, the strongest RSRP). The reference direction and reference subband corresponding to the optimal measurement result (for example, the strongest RSRP) may be used as the reference direction and reference subband in the subsequent operation.

Based on the wide beam corresponding to the reference direction as the reference wide beam and the auxiliary beam in the combination, the base station may determine the arrival angle of the terminal and the narrow beam index for the terminal (for example, by using the above method).

The base station may receive data from or transmit data to the terminal based on the determined narrow beam index (for example, using the narrow beam corresponding to the narrow beam index).

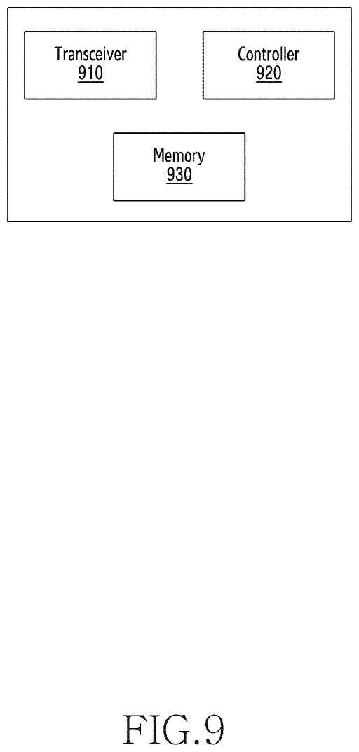

FIG. 9 is a block diagram of a first node (e.g., a terminal) as a scheduled node according to an embodiment of the disclosure.

Referring to FIG. 9, the first node includes a transceiver 910, a controller 920, and a memory 930. The controller 920 may refer to a circuit, an application specific integrated circuit (ASIC), or at least one processor. The transceiver 910, the controller 920, and the memory 930 are configured to perform the above-described operations that can be performed by the terminal or the UE. Although the transceiver 910, the controller 920, and the memory 930 are shown as separate entities, they may be implemented as a single entity, such as a single chip. Alternatively, the transceiver 910, the controller 920, and the memory 930 may be electrically connected or coupled to each other.

The transceiver 910 may transmit and receive signals to and from other network entities (e.g., a base station).

The controller 920 may control the first node to perform a function according to one of the various example embodiments described above.

In some example embodiments, the operations of the first node may be implemented using a memory 930 storing respective program codes. In particular, the first node may be equipped with a memory 930 to store program code implementing desired operations. In order to perform desired operations, the controller 920 may read and execute program codes stored in the memory 930 by using at least one processor or central processing unit (CPU).

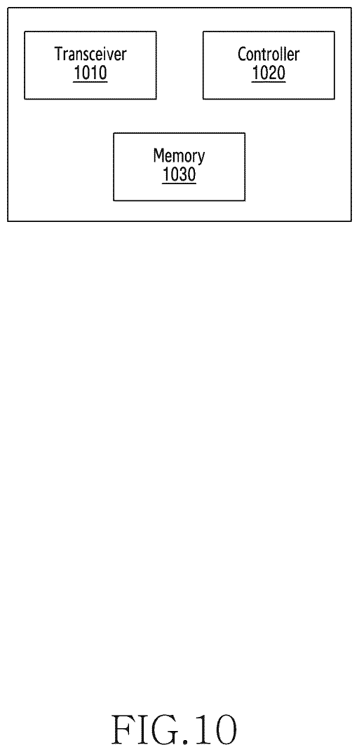

FIG. 10 is a block diagram of a second node (e.g., a base station) as a scheduling node according to an embodiment of the disclosure.

Referring to FIG. 10, the second node includes a transceiver 1010, a controller 1020, and a memory 1030. The controller 1020 may refer to a circuit, an application specific integrated circuit (ASIC), or at least one processor. The transceiver 1010, the controller 1020, and the memory 1030 are configured to perform the operations described above that can be performed by the base station. Although the transceiver 1010, the controller 1020, and the memory 1030 are shown as separate entities, they may be implemented as a single entity, such as a single chip. Alternatively, the transceiver 1010, the controller 1020, and the memory 1030 may be electrically connected or coupled to each other.

The transceiver 1010 may transmit and receive signals to and from other network entities (e.g., terminals).

The controller 1020 may control the second node to perform a function according to one of the various example embodiments described above.

In some example embodiments, the operations of the second node may be implemented using a memory 1030 storing respective program codes. In particular, the second node may be equipped with a memory 1030 to store program code implementing desired operations. In order to perform desired operations, the controller 1020 may read and execute program codes stored in the memory 1030 by using at least one processor or central processing unit (CPU).

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure as generally described herein and shown in the drawings may be arranged, replaced, combined, separated, and designed in various different configurations, all of which are contemplated herein.

Those skilled in the art will understand that the various illustrative logic blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described function sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, multiple microprocessors, one or more microprocessors cooperating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. A storage medium is coupled to a processor to enable the processor to read and write information from/to the storage medium. In an alternative, the storage medium may be integrated into the processor. The processor and the storage medium may reside in an ASIC. The ASIC may reside in a communication apparatus (e.g., a terminal or a base station). In an alternative, the processor and the storage medium may reside in a communication apparatus (e.g., a terminal or a base station) as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that may be accessed by a general purpose or special purpose computer.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information including information on a plurality of frequency units of a channel state information (CSI) reference signal (RS);
performing a channel measurement based on the plurality of frequency units of the CSI RS; and
transmitting, to the base station, a CSI report including a channel measurement result of the channel measurement,
wherein the channel measurement result is associated with at least one frequency unit among the plurality of frequency units.

2. The method of claim 1, wherein the plurality of frequency units includes at least one of a sub band, a physical resource block group (RBG), or a bandwidth (BWP), and
wherein each of the plurality of frequency units is associated with different beam direction.

3. The method of claim 1, wherein the configuration information further includes information on a plurality of time units corresponding to the plurality of frequency units.

4. The method of claim 3, wherein the configuration information is received from the base station via at least one of a downlink control information (DCI), a radio resource control (RRC) message, or a medium access control (MAC) control element (CE).

5. The method of claim 1, wherein the information on the plurality of frequency units includes information on a frequency position of each of the plurality of frequency units.

6. A method performed by a base station in a wireless communication system, the method comprising:
transmitting, to a user equipment (UE), configuration information including information on a plurality of frequency units of a channel state information (CSI) reference signal (RS);
transmitting, to the UE, the CSI RS for a channel measurement associated with the plurality of frequency units of the CSI RS; and
receiving, from the UE, a CSI report including a channel measurement result of the channel measurement,
wherein the channel measurement result is associated with at least one frequency unit among the plurality of frequency units.

7. The method of claim 6, wherein the plurality of frequency units includes at least one of a sub band, a physical resource block group (RBG), or a bandwidth (BWP), and
wherein each of the plurality of frequency units is associated with different beam direction.

8. The method of claim 6, wherein the configuration information further includes information on a plurality of time units corresponding to the plurality of frequency units.

9. The method of claim 8, wherein the configuration information is transmitted to the UE via at least one of a downlink control information (DCI), a radio resource control (RRC) message, or a medium access control (MAC) control element (CE).

10. The method of claim 6, wherein the information on the plurality of frequency units includes information on a frequency position of each of the plurality of frequency units.

11. A user equipment (UE) in a wireless communication system, the UE comprising:
a transceiver; and
a controller coupled with the transceiver and configured to:
receive, from a base station, configuration information including information on a plurality of frequency units of a channel state information (CSI) reference signal (RS),
perform a channel measurement based on the plurality of frequency units of the CSI RS, and
transmit, to the base station, a CSI report including a channel measurement result of the channel measurement,
wherein the channel measurement result is associated with at least one frequency unit among the plurality of frequency units.

12. The UE of claim 11, wherein the plurality of frequency units includes at least one of a sub band, a physical resource block group (RBG), or a bandwidth (BWP), and
wherein each of the plurality of frequency units is associated with different beam direction.

13. The UE of claim 11, wherein the configuration information further includes information on a plurality of time units corresponding to the plurality of frequency units.

14. The UE of claim 13, wherein the configuration information is received from the base station via at least one of a downlink control information (DCI), a radio resource control (RRC) message, or a medium access control (MAC) control element (CE).

15. The UE of claim 11, wherein the information on the plurality of frequency units includes information on a frequency position of each of the plurality of frequency units.

16. A base station in a wireless communication system, the base station comprising:
a transceiver; and
a controller coupled with the transceiver and configured to:
transmit, to a user equipment (UE), configuration information including information on a plurality of frequency units of a channel state information (CSI) reference signal (RS),
transmit, to the UE, the CSI RS for a channel measurement associated with the plurality of frequency units of the CSI RS, and
receive, from the UE, a CSI report including a channel measurement result of the channel measurement,
wherein the channel measurement result is associated with at least one frequency unit among the plurality of frequency units.

17. The base station of claim 16, wherein the plurality of frequency units includes at least one of a sub band, a physical resource block group (RBG), or a bandwidth (BWP), and
wherein each of the plurality of frequency units is associated with different beam direction.

18. The base station of claim 16, wherein the configuration information further includes information on a plurality of time units corresponding to the plurality of frequency units.

19. The base station of claim 18, wherein the configuration information is transmitted to the UE via at least one of a downlink control information (DCI), a radio resource control (RRC) message, or a medium access control (MAC) control element (CE).

20. The base station of claim 16, wherein the information on the plurality of frequency units includes information on a frequency position of each of the plurality of frequency units.
